(19) United States
(12) Patent Application Publication
(10) Pub. No.: US 2023/0262068 A1
(43) Pub. Date: Aug. 17, 2023

(54) METHODS AND APPARATUSES FOR MANAGING NETWORK SECURITY USING VIDEO SURVEILLANCE AND ACCESS CONTROL SYSTEM

(71) Applicant: Johnson Controls Tyco IP Holdings LLP, Milwaukee, WI (US)

(72) Inventor: Alexis B. EHRLICH, Boca Raton, FL (US)

(21) Appl. No.: 17/674,524

(22) Filed: Feb. 17, 2022

(51) Int. Cl. H04L 9/40; G06K 7/14

(52) U.S. Cl. CPC H04L 63/108; H04L 63/08; G06K 7/1417; G06K 7/1413

(57) ABSTRACT

Aspects of the present disclosure include a method, a system, and/or a non-transitory computer readable medium for generating a visual code visual code associated with access to an access-controlled asset, wherein the visual code expires after an amount of time or at an expiration time, transmitting the visual code to a dedicated access device of a requester, receiving an image of the visual code displayed by the dedicated access device, determining whether to grant access to the access-controlled asset by verifying authentication of the visual code, and sending a signal to the access-controlled asset granting access to the requester associated with the dedicated access device.

### BACKGROUND

In a secure environment of an organization, access-controlled assets may require authorized users to provide authentication information prior to granting the authorized users access to the assets. Examples of authentication information may include visual codes, user names, passwords, key fobs, access cards, and/or personal identification numbers (PINs). In a secure environment that requires authenticated visual codes for access, it may be expensive and/or inconvenient to rely on cell phones to present the visual codes. Therefore, improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include a method, a system, and/or a non-transitory computer readable medium for generating a visual code visual code associated with access to an access-controlled asset, wherein the visual code expires after an amount of time or at an expiration time, transmitting the visual code to a dedicated access device of a requester, receiving an image of the visual code displayed by the dedicated access device, determining whether to grant access to the access-controlled asset by verifying authentication of the visual code, and sending a signal to the access-controlled asset granting access to the requester associated with the dedicated access device.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for implementing visual code authentication in accordance with aspects of the present disclosure;

FIG. 2 illustrates an example method for implementing visual code authentication in accordance with aspects of the present disclosure; and

FIG. 3 illustrates an example of a computer system in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

In some aspects of the present disclosure, a requester may present an access card configured to present visual code to an authentication device when requesting access to an access-controlled asset. The visual code may be a temporary code assigned to the requester (e.g., a guest with temporary access to the access-controlled asset). The authentication device may scan the visual code with an image capturing device. Once the visual code is authenticated, the requester may gain access to the access-controlled asset.

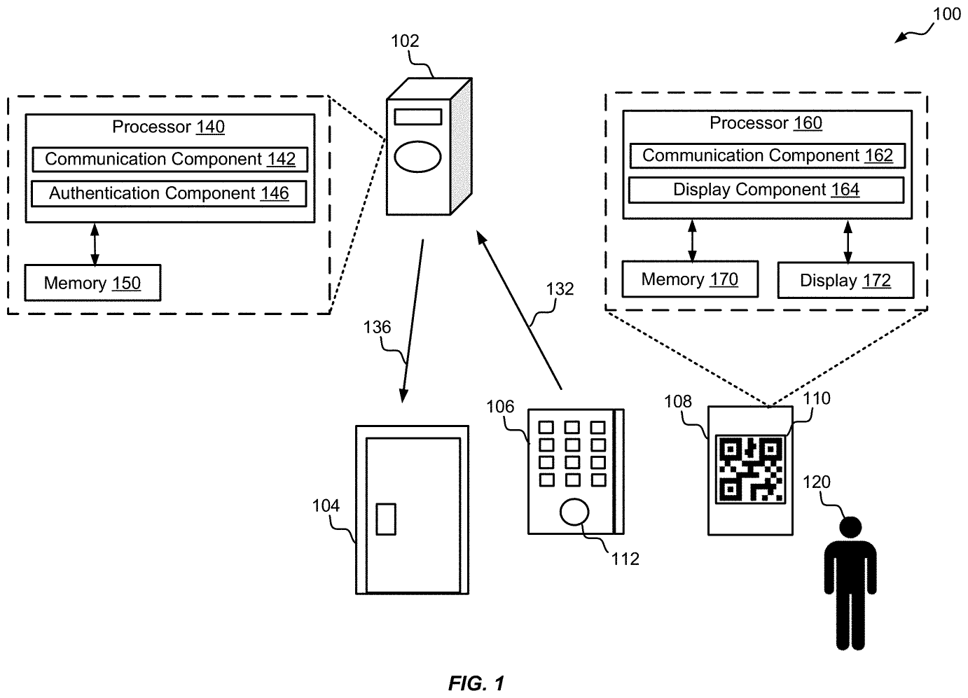

Referring to FIG. 1, in a non-limiting implementation, an example of an environment 100 for implementing visual code authentication is shown according to aspects of the present disclosure. The environment 100 may include an authentication server 102. The environment 100 may include an access-controlled asset 104. The authentication server 102 may control access to the access-controlled asset 104. The environment 100 may include an authentication device 106 configured to scan a dedicated access device 108 of a requester 120 when determining whether to grant the requester 120 access to the access-controlled asset 104. The environment 100 may include the dedicated access device 108 configured to display a visual code 110 configured to be scanned by the authentication device 106. The dedicated access device 108 may be a device configured to function as an electronic device dedicated for accessing the access-controlled asset 104. The dedicated access device 108 may be a badge, a fob, a key card, or other suitable electronic device. Examples of the visual code 110 may include a Quick Response code (QR code), a matrix code, a MSI code, a Pharmacode, a Universal Product Code, and/or other suitable one dimension or two dimension bar codes.

Still referring to FIG. 1, in an aspect of the present disclosure, the authentication server 102 may include a processor 140 that executes instructions stored in a memory 150 for performing the functions described herein.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, controllers, digital signal processors (DSPs), field programmable gate arrays (FPGAs), programmable logic devices (PLDs), state machines, gated logic, discrete hardware circuits, and other suitable hardware configured to perform the various functionality described herein. The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In some aspects, the authentication server 102 may include memory 150. The memory 150 may include software instructions and/or hardware instructions. The processor 140 may execute the instructions to implement aspects of the present disclosure.

In certain aspects, the processor 140 may include a communication component 142 configured to communicate with external devices via one or more wired and/or wireless connections. The processor 140 may include an authentication component 146 configured to authenticate an access request based on the visual code 110 displayed by the dedicated access device 108 of the requester 120. The communication component 142 and/or the authentication component 146 may be implemented hardware (e.g., application specific integrated circuit, application processors, field programmable gate arrays, etc.), software (e.g., instructions stored in the memory 150 and executed by the processor 140), or a combination thereof.

In one aspect of the current disclosure, the dedicated access device 108 may include a processor 160 and a memory 170. The processor 160 may be configured to execute instructions stored in the memory 170 to perform aspects of the present disclosure. The processor 160 may include a communication component 162 configured to communicate with external devices via one or more wired and/or wireless connections. For example, the communication component 162 may be configured to receive the visual code 110 transmitted by an external device. The processor 160 may include a display component 164 configured to display images, such as the visual code 110, stored in the memory 170 via a display 172. The dedicated access device 108 may include a display, such as a liquid crystal display (LCD), a light emitting diode (LED) display, an electroluminescent (EL) display, an incandescence display, a photoluminescence display, a micro electromechanical system (MEMS) display, and/or other suitable electronic visual displays.

In some aspects, the access-controlled asset 104 may be an entrance and/or exit to an infrastructure (not shown), a safe, a cabinet, a computing device, a software, a digital file, an elevator, and/or any other tangible or intangible assets. The authentication device 106 may include an image capturing device 112 configured to capture an image of the visual code 110. Examples of the image capturing device 112 may include a camera, a video recorder, and/or any device configured to capture the visual code 110. Alternatively or additionally, the authentication device 106 may be a reader configured to read a keycard or a key fob, an alphanumeric keypad configured to provide an interface for the requester 120 to input login, password, and/or PIN.

During operation, the requester 120 may present the dedicated access device 108 to the authentication device 106 to gain access to the access-controlled asset 104. The dedicated access device 108 may present the visual code 110 to the authentication device 106. The authentication device 106 may capture the visual code 110 using the image capturing device 112. The authentication device 106 may transmit an access request 132 to the authentication server 102. The authentication device 106 may include the visual code 110, a portion of the visual code 110, and/or information represented by the visual code 110.

In some aspects of the present disclosure, the authentication server 102 may receive the access request 132 from the authentication device 106. The authentication component 146 of the authentication server 102 may determine, based on the access request 132 and/or the visual code 110, whether to grant the requester 120 access to the access-controlled asset 104. For example, the authentication component 146 may compare the visual code 110 (and/or information represented by the visual code 110) with stored visual codes (and/or information represented by the stored visual codes) that indicate permitted access to the access-controlled asset 104. If the authentication component 146 of the authentication server 102 is able to properly authenticate the visual code 110 associated with the access request 132, the authentication server 102 may transmit an access grant 136 to the access-controlled asset 104 to allow the requester 120 access.

In some instances, the dedicated access device 108 may receive the visual code 110 from the authentication server 102. The visual code 110 may be utilized to grant the requester 120 temporary access (e.g., 10 hours, 2 days, 1 week, etc.) to the access-controlled asset 104. The visual code 110 may “expire” after a certain amount time has lapsed and/or at a certain time.

In certain aspects, the visual code 110 may grant the requester 120 access to the access-controlled asset 104 during certain times of a day (e.g., between 8 ante meridiem (AM) and 5 post meridiem (PM)) and/or certain days of a week (e.g., Monday through Friday).

In some aspects, the visual code 110 may grant the requester 120 access to a portion of the access-controlled asset 104. For example, if the access-controlled asset 104 is a building, the visual code 110 may be used to access a first group of rooms in the building but not a second group of rooms in the building.

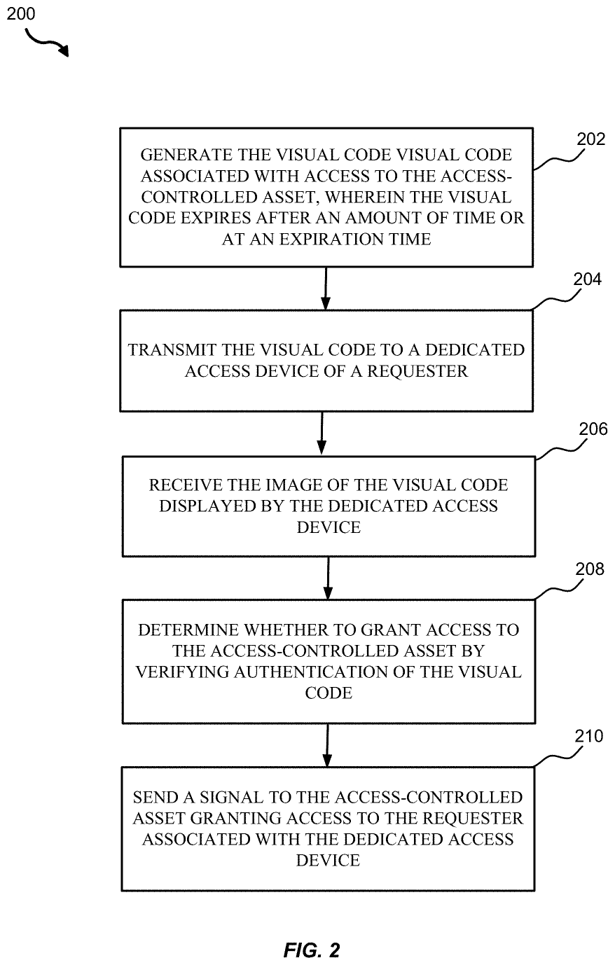

Turning to FIG. 2, an example of a method 200 for implementing visual code authentication may be implemented the authentication server 102, the processor 140, the communication component 142, the authentication component 146, and/or the memory 150.

At block 202, the method 200 may generate the visual code visual code associated with access to the access-controlled asset, wherein the visual code expires after an amount of time or at an expiration time. For example, the processor 140, the authentication component 146, and/or the memory 150 may generate the visual code visual code associated with access to the access-controlled asset, wherein the visual code expires after an amount of time or at an expiration time. The processor 140, the authentication component 146, and/or the memory 150 may be configured to and/or define means for generating the visual code visual code associated with access to the access-controlled asset, wherein the visual code expires after an amount of time or at an expiration time.

At block 204, the method 200 may transmit the visual code to a dedicated access device of a requester. For example, the processor 140, the communication component 142, and/or the memory 150 may transmit the visual code to a dedicated access device of a requester. The processor 140, the communication component 142, and/or the memory 150 may be configured to and/or define means for transmitting the visual code to a dedicated access device of a requester.

At block 206, the method 200 may receive the image of the visual code displayed by the dedicated access device. For example, the processor 140, the communication component 142, and/or the memory 150 may receive the image of the visual code displayed by the dedicated access device. The processor 140, the communication component 142, and/or the memory 150 may be configured to and/or define means for receiving the image of the visual code displayed by the dedicated access device.

At block 208, the method 200 may determine whether to grant access to the access-controlled asset by verifying authentication of the visual code. For example, the processor 140, the authentication component 146, and/or the memory 150 may determine whether to grant access to the access-controlled asset by verifying authentication of the visual code. The processor 140, the authentication component 146, and/or the memory 150 may be configured to and/or define means for determining whether to grant access to the access-controlled asset by verifying authentication of the visual code.

At block 210, the method 200 may send a signal to the access-controlled asset granting access to the requester associated with the dedicated access device. For example, the processor 140, the communication component 142, and/or the memory 150 may send a signal to the access-controlled asset granting access to the requester associated with the dedicated access device. The processor 140, the communication component 142, and/or the memory 150 may be configured to and/or define means for sending a signal to the access-controlled asset granting access to the requester associated with the dedicated access device.

Aspects of the present disclosure may include the method above, wherein the visual code is a Quick Response code (QR code), a matrix code, a MSI code, a Pharmacode, a Universal Product Code, a one dimensional bar code, and/or a two dimensional bar code.

Aspects of the present disclosure may include any of the methods above, wherein the visual code expires after an amount of time or at an expiration time.

Aspects of the present disclosure may include any of the methods above, wherein the visual code grants access to the access-controlled asset during one or more times of a day.

Aspects of the present disclosure may include any of the methods above, wherein the visual code grants access to the access-controlled asset during one or more days of a week.

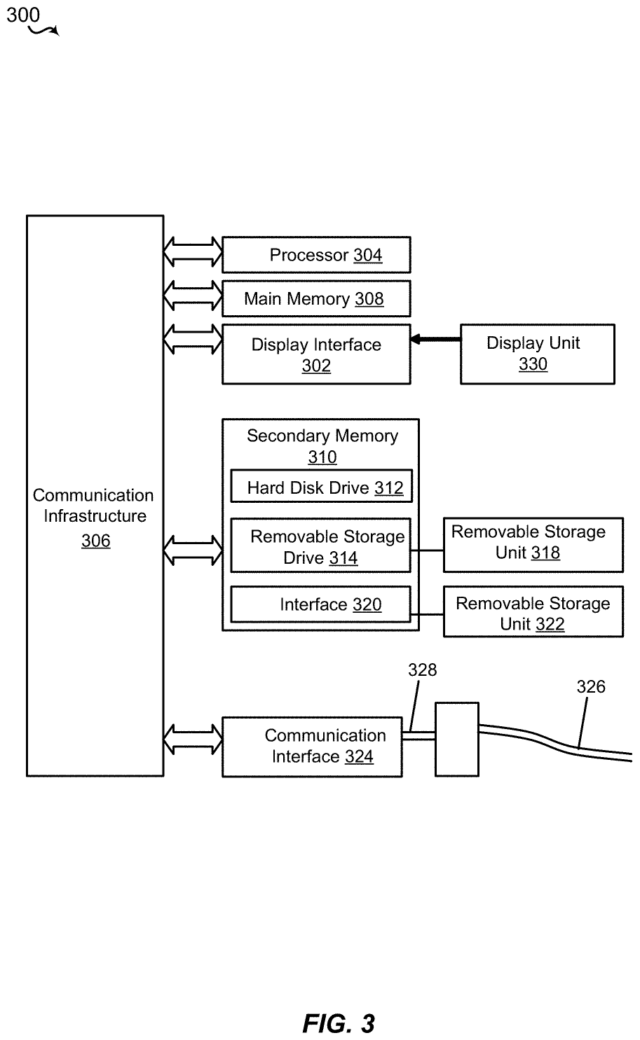

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 300 is shown in FIG. 3. In some examples, the authentication server 102, the authentication device 106, and/or the dedicated access device 108 may be implemented as the computer system 300 shown in FIG. 3. The authentication server 102, the authentication device 106, and/or the dedicated access device 108 may include some or all of the components of the computer system 300.

The computer system 300 includes one or more processors, such as processor 304. The processor 304 is connected with a communication infrastructure 306 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 300 may include a display interface 302 that forwards graphics, text, and other data from the communication infrastructure 306 (or from a frame buffer not shown) for display on a display unit 330. Computer system 300 also includes a main memory 308, preferably random access memory (RAM), and may also include a secondary memory 310. The secondary memory 310 may include, for example, a hard disk drive 312, and/or a removable storage drive 314, representing a floppy disk drive, a magnetic tape drive, an optical disk drive, a universal serial bus (USB) flash drive, etc. The removable storage drive 314 reads from and/or writes to a removable storage unit 318 in a well-known manner. Removable storage unit 318 represents a floppy disk, magnetic tape, optical disk, USB flash drive etc., which is read by and written to removable storage drive 314. As will be appreciated, the removable storage unit 318 includes a computer usable storage medium having stored therein computer software and/or data. In some examples, one or more of the main memory 308, the secondary memory 310, the removable storage unit 318, and/or the removable storage unit 322 may be a non-transitory memory.

Alternative aspects of the present disclosures may include secondary memory 310 and may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and the removable storage unit 322 and the interface 320, which allow software and data to be transferred from the removable storage unit 322 to computer system 300.

Computer system 300 may also include a communications circuit 324. The communications circuit 324 may allow software and data to be transferred between computer system 300 and external devices. Examples of the communications circuit 324 may include a modem, a network interface (such as an Ethernet card), a communications port, a Personal Computer Memory Card International Association (PCMCIA) slot and card, etc. Software and data transferred via the communications circuit 324 are in the form of signals 328, which may be electronic, electromagnetic, optical or other signals capable of being received by the communications circuit 324. These signals 328 are provided to the communications circuit 324 via a communications path (e.g., channel) 326. This path 326 carries signals 328 and may be implemented using wire or cable, fiber optics, a telephone line, a cellular link, an RF link and/or other communications channels. In this document, the terms “computer program medium” and “computer usable medium” are used to refer generally to media such as the removable storage unit 318, a hard disk installed in hard disk drive 312, and signals 328. These computer program products provide software to the computer system 300. Aspects of the present disclosures are directed to such computer program products.

Computer programs (also referred to as computer control logic) are stored in main memory 308 and/or secondary memory 310. Computer programs may also be received via communications circuit 324. Such computer programs, when executed, enable the computer system 300 to perform the features in accordance with aspects of the present disclosures, as discussed herein. In particular, the computer programs, when executed, enable the processor 304 to perform the features in accordance with aspects of the present disclosures. Accordingly, such computer programs represent controllers of the computer system 300.

In an aspect of the present disclosures where the method is implemented using software, the software may be stored in a computer program product and loaded into computer system 300 using removable storage drive 314, hard disk drive 312, or the interface 320. The control logic (software), when executed by the processor 304, causes the processor 304 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A security system, comprising:
an access-controlled asset;
an authentication device configured to capture an image of a visual code; and
an authentication server comprising:
a memory including instructions; and
a processor configured to execute the instructions to:
generate the visual code visual code associated with access to the access-controlled asset, wherein the visual code expires after an amount of time or at an expiration time;
transmit the visual code to a dedicated access device of a requester;
receive the image of the visual code displayed by the dedicated access device;
determine whether to grant access to the access-controlled asset by verifying authentication of the visual code; and
send a signal to the access-controlled asset granting access to the requester associated with the dedicated access device.

2. The security system of claim 1, wherein the visual code is a Quick Response code (QR code), a matrix code, a MSI code, a Pharmacode, a Universal Product Code, a one dimensional bar code, and/or a two dimensional bar code.

3. The security system of claim 1, wherein:
the access-controlled asset is a building; and
the visual code grants access to a first plurality of assets in the building and is denied access to a second plurality of assets in the building.

4. The access device of claim 1, wherein the visual code grants access to the access-controlled asset during one or more times of a day.

5. The access device of claim 1, wherein the visual code grants access to the access-controlled asset during one or more days of a week.

6. A method by an authentication server, comprising:
generating a visual code visual code associated with access to an access-controlled asset, wherein the visual code expires after an amount of time or at an expiration time;
transmitting the visual code to a dedicated access device of a requester;
receiving an image of the visual code displayed by the dedicated access device;
determining whether to grant access to the access-controlled asset by verifying authentication of the visual code; and
sending a signal to the access-controlled asset granting access to the requester associated with the dedicated access device.

7. The method of claim 6, wherein the visual code is a Quick Response code (QR code), a matrix code, a MSI code, a Pharmacode, a Universal Product Code, a one dimensional bar code, and/or a two dimensional bar code.

8. The method of claim 6, wherein:
the access-controlled asset is a building; and
the visual code grants access to a first plurality of assets in the building and is denied access to a second plurality of assets in the building.

9. The method of claim 6, wherein the visual code grants access to the access-controlled asset during one or more times of a day.

10. The method of claim 6, wherein the visual code grants access to the access-controlled asset during one or more days of a week.

11. A non-transitory computer readable medium comprising instructions that, when executed by a processor, cause the processor to:
generate the visual code visual code associated with access to the access-controlled asset, wherein the visual code expires after an amount of time or at an expiration time;
transmit the visual code to a dedicated access device of a requester;
receive the image of the visual code displayed by the dedicated access device;
determine whether to grant access to the access-controlled asset by verifying authentication of the visual code; and
send a signal to the access-controlled asset granting access to the requester associated with the dedicated access device.

12. The non-transitory computer readable medium of claim 11, wherein the visual code is a Quick Response code (QR code), a matrix code, a MSI code, a Pharmacode, a Universal Product Code, a one dimensional bar code, and/or a two dimensional bar code.

13. The non-transitory computer readable medium of claim 11, wherein:
the access-controlled asset is a building; and
the visual code grants access to a first plurality of assets in the building and is denied access to a second plurality of assets in the building.

14. The non-transitory computer readable medium of claim 11, wherein the visual code grants access to the access-controlled asset during one or more times of a day.

15. The non-transitory computer readable medium of claim 11, wherein the visual code grants access to the access-controlled asset during one or more days of a week.

16. A dedicated access device of a requester, comprising:
a display;
a memory including instructions;
a processor configured to execute the instructions to:
receive a visual code associated with access to the access-controlled asset, wherein the visual code expires after an amount of time or at an expiration time; and
display an image of the visual code, wherein the requester is granted access to the access-controlled asset in response to authentication of the visual code; and
wherein the dedicated access device is dedicated for accessing the access-controlled asset.
